(19) United States
(12) Patent Application Publication
(10) Pub. No.: US 2008/0050064 A1
(43) Pub. Date: Feb. 28, 2008

(54) MEMS optical switch device

(75) Inventors: Yoshio Sakai, Kawasaki (JP); Kazuyuki Mori, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/591,590

(22) Filed: Nov. 2, 2006

(30) Foreign Application Priority Data
Aug. 28, 2006 (JP) PAT. 2006-230975

(51) Int. Cl. G02B 6/26

(52) U.S. Cl. 385/17

(57) ABSTRACT

A MEMS optical switch device is disclosed that includes an optical system deflecting and outputting light signals; first and second test light generation parts generating and feeding first and second test lights to specific input and output ports, respectively, of the optical system; first and second divergence parts diverging the first and second test lights, respectively, from the optical system; first and second monitoring parts detecting the diverged first and second test lights, respectively; and an operational check part causing the first and second test lights to be incident on output and input deflection parts of the optical system by driving a specific input deflection part corresponding to the specific input port and a specific output deflection part corresponding to the specific output port, respectively, and performing an operational check on the output and input deflection parts from the light levels of the detected first and second test lights, respectively.

### BACKGROUND OF THE INVENTION

1. Field of the Invention

The present invention relates generally to MEMS (Micro Electro Mechanical Systems) optical switch devices, and more particularly to a MEMS optical switch device that is an optical switch using a MEMS mirror.

2. Description of the Related Art

Wavelength division multiplexing (WDM) is an effective technique for constituting a large-capacity optical communications network, and WDM traffic has been exploding these days with the explosive spread of the Internet.

A common optical cross-connect (OXC) system as a backbone optical network according to WDM is formed of multiple optical signal exchangers interconnected by optical fibers. When a WDM light signal is input to the optical signal exchanger through an optical fiber, the optical signal exchanger switches the route of the light signal wavelength by wavelength, and can transmit light signals in the same route in the form of a WDM light signal.

According to such an optical cross-connect system, if an optical fiber forming a communications route fails, it is possible to restore the system at high speed by immediately performing automatic bypassing to a backup optical fiber or the optical fiber of another route. Further, it is also possible to edit optical paths wavelength by wavelength.

In the MEMS optical switch, concern about reliability is greatest for a MEMS mirror that mechanically operates among the components of the optical switch. It is necessary to detect failure of the MEMS mirror in order to increase the reliability of an optical communications system.

In the conventional MEMS optical switch, light sources are connected to all the input ports of an optical switch through corresponding couplers, and abnormality is detected by monitoring the output levels of all the output ports of the optical switch as described in Patent Document 1.

Further, according to Patent Document 2, each of an input port group and an output port group includes a port dedicated to an alignment test. A representative alignment characteristic is measured using the dedicated ports, and other mirrors are corrected based on the measurement result.

[Patent Document 1] Japanese Laid-Open Patent Application No. 2004-48187

[Patent Document 2] Japanese Laid-Open Patent Application No. 2005-57788

However, according to the conventional MEMS optical switch of Patent Document 1, the light sources of test light are connected to all the input ports and the output levels of all the output ports are monitored, thereby detecting abnormality. Accordingly, the number of test light sources increases so as to cause the problem of an increase in cost and device size.

### SUMMARY OF THE INVENTION

Embodiments of the present invention may solve or reduce the above-described problem.

According to one embodiment of the present invention, there is provided a MEMS optical switch device in which the above-described problem is eliminated.

According to one embodiment of the present invention, there is provided a MEMS optical switch device that can significantly reduce the number of light sources of test light for abnormality detection and thereby can reduce the cost and size of the device.

According to one embodiment of the present invention, there is provided a micro electro mechanical systems optical switch device including an optical system configured to deflect light signals input from a plurality of input ports thereof with a plurality of input deflection parts and a plurality of output deflection parts on a channel-by-channel basis, and to output the light signals from a plurality of output ports thereof; a first test light generation part configured to generate first test light and feed the first test light to at least one specific input port of the input ports of the optical system; a first divergence part configured to diverge the first test light fed from the optical system, the first divergence part being provided for each of the output ports of the optical system; a first monitoring part configured to detect the first test light diverged by the first divergence part; a second test light generation part configured to generate second test light and feed the second test light to at least one specific output port of the output ports of the optical system; a second divergence part configured to diverge the second test light fed from the optical system, the second divergence part being provided for each of the input ports of the optical system; a second monitoring part configured to detect the second test light diverged by the second divergence part; and an operational check part configured to cause the first test light to be incident on the output deflection parts one after another by driving a specific one of the input deflection parts corresponding to the at least one specific input port, and perform an operational check on the output deflection parts from a light level of the first test light detected by the first monitoring part; and to cause the second test light to be incident on the input deflection parts one after another by driving a specific one of the output deflection parts corresponding to the at least one specific output port, and perform an operational check on the input deflection parts from a light level of the second test light detected by the second monitoring part.

According to one aspect of the present invention, it is possible to significantly reduce the number of light sources of test light for abnormality detection, so that it is possible to reduce the cost and size of a MEMS optical switch device.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a MEMS optical switch device according to an embodiment of the present invention;

FIG. 2 is a structure diagram showing an output MEMS mirror operational check according to the embodiment of the present invention;

FIG. 3 is a structure diagram showing an input MEMS mirror operational check according to the embodiment of the present invention;

FIG. 4 is a flowchart of the output MEMS mirror operational check according to the embodiment of the present invention;

FIG. 5 is a flowchart of the input MEMS mirror operational check according to the embodiment of the present invention; and

FIG. 6 is a flowchart of feedback control according to the embodiment of the present invention.

### DETAILED DESCRIPTION OF THE PREFERRED EMBODIMENTS

A description is given below, with reference to the accompanying drawings, of an embodiment of the present invention.

[Configuration of MEMS Optical Switch Device]

According to a MEMS optical switch device of this embodiment, a light signal input from one of multiple input ports is subjected to switching on a channel-by-channel basis so as to be output selectively from an output port assigned to the one of the input ports. Here, a light signal input to one input port is referred to as one channel irrespective of whether the input light signal is a single-wavelength or WDM signal.

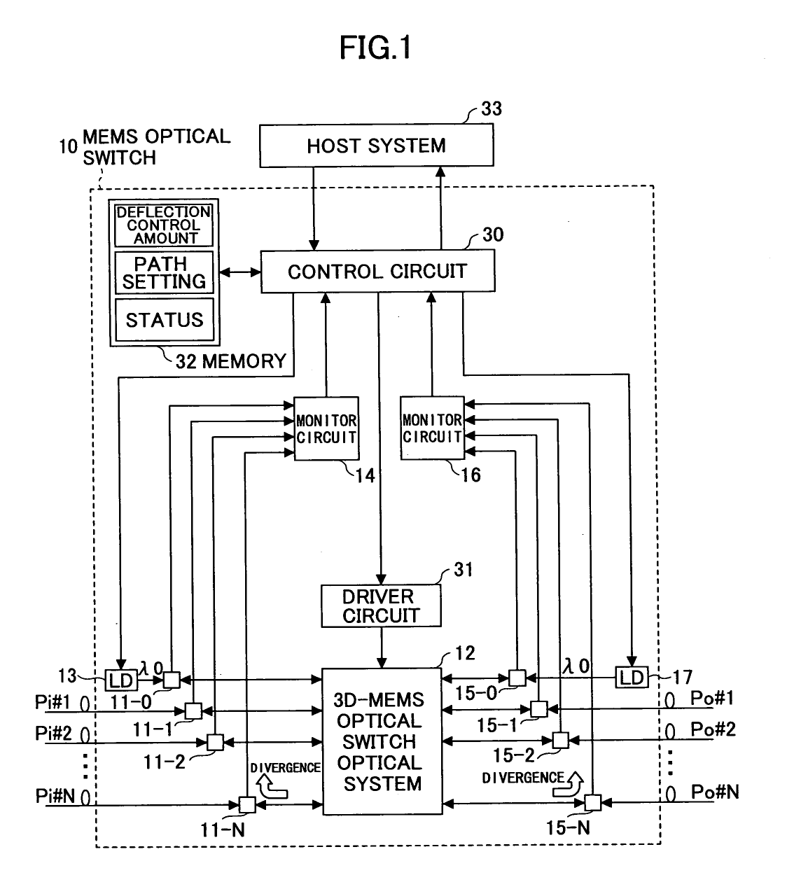

FIG. 1 is a block diagram showing a MEMS optical switch device 10 according to the embodiment of the present invention. Referring to FIG. 1, the MEMS optical switch device 10 has light signals of N channels input thereto from the optical fibers of corresponding input ports Pi#1 through Pi#N. These light signals are fed to a three-dimensional MEMS optical switch optical system 12 through corresponding wavelength filters 11-1 through 11-N. Further, test light of, for example, a wavelength λ0 generated by a laser diode 13 that is a test light source is fed to a wavelength filter 11-0. The wavelength filters 11-0 through 11-N feed the light signals fed from the laser diode 13 and the input ports Pi#1 through Pi#N to the input ports of N+1 channels of the three-dimensional MEMS optical switch optical system 12. Further, the wavelength filters 11-0 through 11-N diverge test light of the wavelength λ0 among light signals fed from the three-dimensional MEMS optical switch optical system 12, and feed the test light to a monitor circuit 14.

The light signals output from the output ports of N+1 channels of the three-dimensional MEMS optical switch optical system 12 are fed to wavelength filters 15-0 through 15-N. The wavelength filters 15-0 through 15-N diverge the test light of the wavelength λ0 among the light signals fed from the N+1 output ports of the three-dimensional MEMS optical switch optical system 12, and feed the test light to a monitor circuit 16. Further, the wavelength filters 15-0 through 15-N output the light signals other than that of the wavelength λ0 to the optical fibers of a laser diode 17 and output ports Po#1 through Po#N. The test light of the wavelength λ0 generated by the laser diode 17, which is a test light source, is fed to one or more of the output ports of the three-dimensional MEMS optical switch optical system 12 through the wavelength filter 15-0.

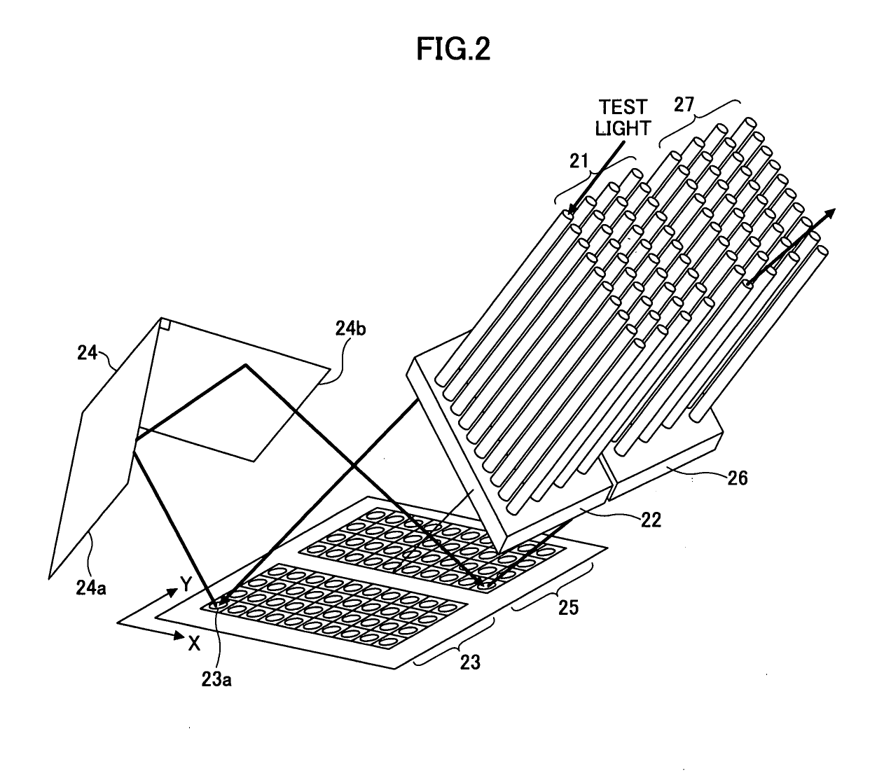

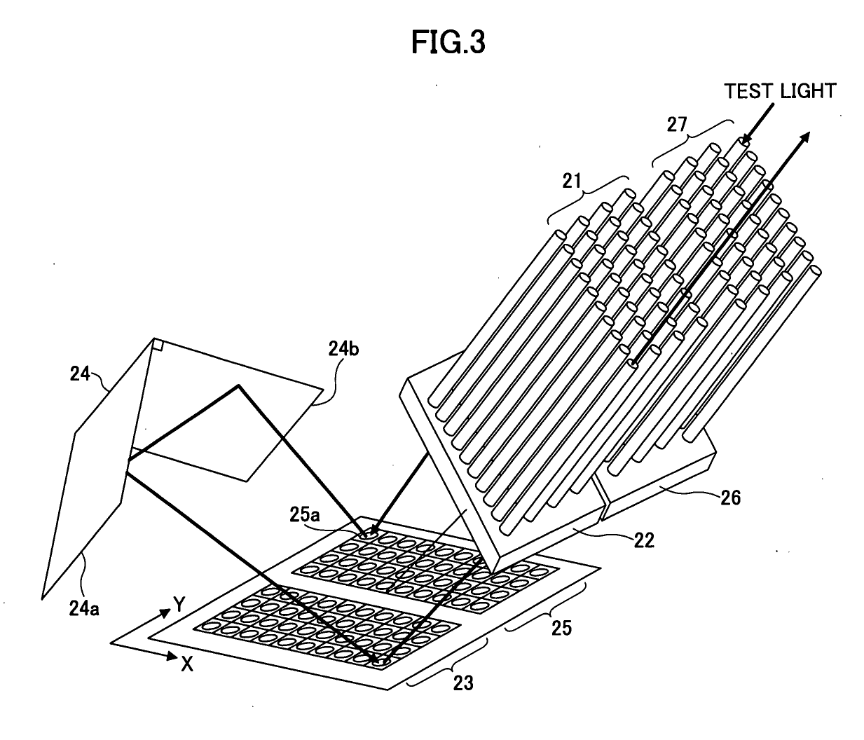

As shown in the structure diagrams of FIGS. 2 and 3, the three-dimensional MEMS optical switch optical system 12 includes an array of two-dimensionally arranged input optical fibers for N+1 channels (an input optical fiber array) 21, an array of two-dimensionally arranged input collimators for N+1 channels (an input collimator array) 22, an array of two-dimensionally arranged input MEMS mirrors for N+1 channels (an input MEMS mirror array) 23, a bending mirror 24, an array of two-dimensionally arranged output MEMS mirrors for N+1 channels (an output MEMS mirror array) 25, an array of two-dimensionally arranged output collimators for N+1 channels (an output collimator array) 26, and an array of two-dimensionally arranged output optical fibers for N+1 channels (an output optical fiber array) 27.

The light signal of each channel input from the input optical fiber array 21 is converted into collimated light in the input collimator array 22 so as to be input to the input MEMS mirror array 23.

Each of the input MEMS mirror array 23 and the output MEMS mirror arrays 25 is an array of N+1 tilt mirrors disposed on a plane. Each tilt mirror has rotation axes parallel to the X-axis and Y-axis. Each tilt mirror is driven by a driver circuit 31 (FIG. 1) under the control of a control circuit 30 (FIG. 1) described below so as to have the angle of each of the two axes adjusted to reflect signal light.

The signal light reflected from the input MEMS mirror array 23 is reflected by a mirror surface 24a of the bending mirror 24, which is disposed at 45° to the surface of the input MEMS mirror array 23. The signal light is further reflected by a mirror surface 24b of the bending mirror 24, which is at right angles with the mirror surface 24a and disposed at 45° to the surface of the output MEMS mirror array 25 so as to be incident on a corresponding one of the MEMS mirrors of the output MEMS mirror array 25. Further, the signal light of each channel is reflected from the output MEMS mirror array 25 so as to be output to the output optical fiber array 27 through the output collimator array 26.

The angle adjustment of the MEMS mirrors of the input MEMS mirror array 23 determines on which MEMS mirror of the output MEMS mirror array 25 entering light is made incident. The angle adjustment of the MEMS mirrors of the output MEMS mirror array 25 determines to which optical fiber of the output optical fiber array 27 the entering light is output.

Referring back to FIG. 1, a memory 32 is connected to the control circuit 30. The memory 32 stores information on deflection control amounts (initial values) for performing switching between the channels of the input optical fiber array 21 and the channel output ports of the output optical fiber array 27 as a database. Further, the memory 32 retains path setting information from a host system 33, and also stores status information in the optical switch device 10, such as an alarm.

A description is given of the wavelength filters 11-0 through 11-N and 15-0 and 15-N. Light input from the output port side is 100% diverged to the monitor circuit 14 by the wavelength filters 11-0 through 11-N connected to the corresponding input ports.

Light input from the input side should be subjected to feedback control with a light signal in actual operation. Accordingly, if the wavelength λ0 of test light and an operating wavelength are in the same band, the output light of the laser diode 13 has such a low level as to cause no problem even if the test light leaks from the output ports, and is amplified in the monitor circuit 16.

On the other hand, if the wavelength of a light signal input from the input port side and the operating wavelength are in different bands, the light signal is 100% diverged to the monitor circuit 16 by the wavelength filters 15-0 through 15-N connected to the output port side. In this case, the wavelength filters 15-0 through 15-N have a divergence ratio of 5 to 10% for the operating wavelength so as to have the characteristic that feedback control is also performable with an operating light signal.

The monitor circuits 14 and 16 monitor light signals diverged by the wavelength filters 11-0 through 11-N and the wavelength filters 15-0 through 15-N, respectively. For example, each of the monitor circuits 14 and 16 includes a photodiode that outputs an electrical signal (a photocurrent or a current signal) according to the level of each light signal; and a current-voltage converter that converts the photocurrent into a voltage signal and outputs the voltage signal.

The driver circuit 31 receives a digital control amount from the control circuit 30, and coverts the digital control amount into an analog control amount, thereby performing variable control of the angle of each tilt mirror of the input MEMS mirror array 23 and the angle of each tilt mirror of the output MEMS mirror array 25. That is, the driver circuit 31 changes the state of deflection of the light signal of each channel of the three-dimensional MEMS optical switch optical system 12.

The control circuit 30 controls the driver circuit 31 based on the monitoring results from the monitor circuits 14 and 16 so as to determine the state of deflection in the three-dimensional MEMS optical switch optical system 12. For example, the control circuit 30 may be configured of an ASIC (Application Specific Integrated Circuit) such as an FPGA (Field Programmable Gate Array).

In the case of receiving a path setting request from the host system 33, the control circuit 30 reads out from the memory 32 a deflection control amount necessary for the path connection of the path setting request, and controls the driver circuit 31. Further, with respect to an unconnected path, the control circuit 30 conducts a path connection test using the test light input from the laser diodes 13 and 17, thereby constantly performing an operational check of the three-dimensional MEMS optical switch optical system 12. If an abnormal light level is detected, the control circuit 30 reports the abnormality to the host system 33.

The laser diodes 13 and 17 are for performing an operational check of the MEMS mirrors of the three-dimensional MEMS optical switch optical system 12. Test light may be input to any wavelength filter.

If the three-dimensional MEMS optical switch optical system 12 has a redundant configuration, for example, if the input ports, the output ports, the input MEMS mirror array 23, and the output MEMS mirror array 25 for 144 channels are disposed, and switching is performed on light signals of 128 channels, the redundant 16 channels can be employed as test ports. The redundant 16 channels are connected to the laser diodes 13 and 17, and test light is input thereto.

[Operational Check Method]

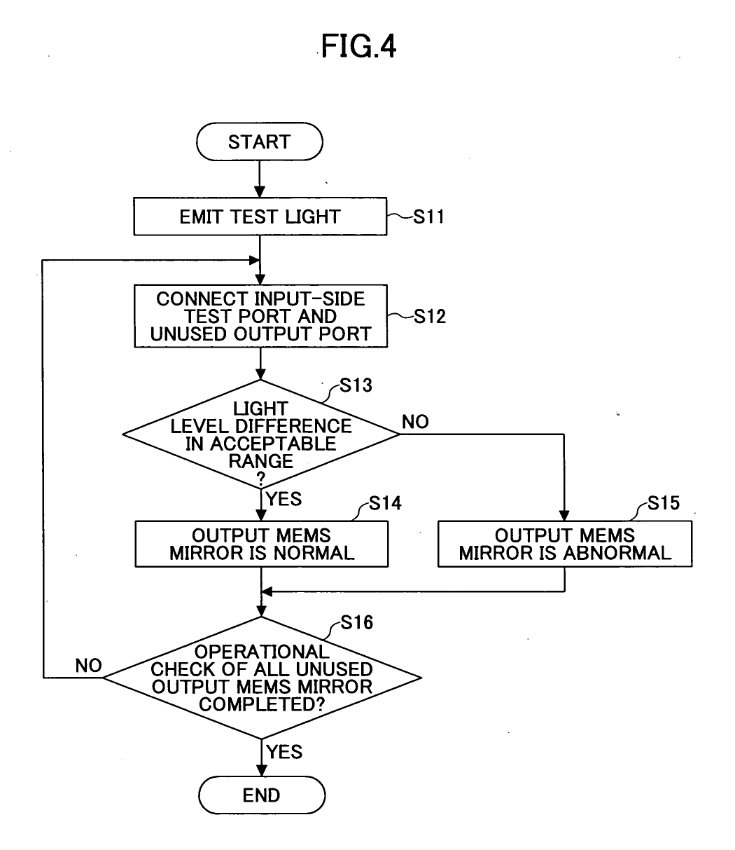

FIG. 4 is a flowchart of an output MEMS mirror operational check performed by the control circuit 30. FIG. 2 shows this output MEMS mirror operational check. In FIG. 4, in step S11, the laser diode 13 is caused to emit test light.

Next, in step S12, the control circuit 30 extracts (selects) an unused one (whose operation has not been checked) of the output MEMS mirrors of the output MEMS mirror array 25, referring to the path setting information of the memory 32. The control circuit 30 performs deflection control between an input MEMS mirror 23a (FIG. 2) of the input MEMS mirror array 23 to which the test light is input and the extracted unused output MEMS mirror based on the deflection control amount information (initial value) contained in the memory 32. Thereafter, the control circuit 30 performs feedback control on the input MEMS mirror 23a and the extracted unused output MEMS mirror so as to maximize the light level (minimize the loss) of the test light detected in the monitor circuit 16.

Next, in step S13, the control circuit 30 determines whether the difference between the light level of the test light generated by the laser diode 13 and the detected light level is within an acceptable range. If the difference is within the acceptable range (YES in step S13), in step S14, the control circuit 30 determines that the output MEMS mirror is operating normally, and writes status information into the memory 32 correspondingly. If the difference is out of the acceptable range (NO in step S13), in step S15, the control circuit 30 determines that the output MEMS mirror is out of order, and writes status information into the memory 32 correspondingly.

Thereafter, in step S16, the control circuit 30 determines whether the operational check has been performed on all the unused output MEMS mirrors of the output MEMS mirror arrays 25. If the operational check has not been performed on all the unused output MEMS mirrors of the output MEMS mirror arrays 25 (NO in step S16), the control circuit 30 proceeds to step S12 so as to repeat steps S12 through S16. Thus, the unused output MEMS mirrors are sequentially subjected to this operational check one by one.

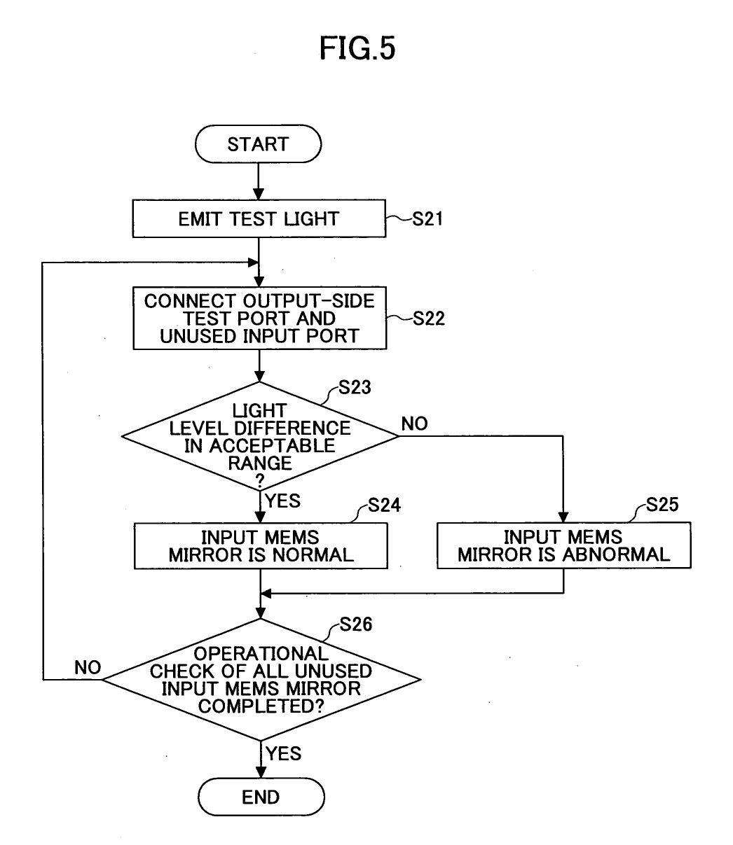

FIG. 5 is a flowchart of an input MEMS mirror operational check performed by the control circuit 30. FIG. 3 shows this input MEMS mirror operational check. In FIG. 5, in step S21, the laser diode 17 is caused to emit test light.

Next, in step S22, the control circuit 30 extracts an unused one (whose operation has not been checked) of the input MEMS mirrors of the input MEMS mirror array 23, referring to the path setting information of the memory 32. The control circuit 30 performs deflection control between an output MEMS mirror 25a (FIG. 3) of the output MEMS mirror array 25 to which the test light is input and the extracted unused input MEMS mirror based on the deflection control amount information (initial value) contained in the memory 32. Thereafter, the control circuit 30 performs feedback control on the output MEMS mirror 25a and the extracted unused input MEMS mirror so as to maximize the light level (minimize the loss) of the test light detected in the monitor circuit 14.

Next, in step S23, the control circuit 30 determines whether the difference between the light level of the test light generated by the laser diode 17 and the detected light level is within an acceptable range. If the difference is within the acceptable range (YES in step S23), in step S24, the control circuit 30 determines that the input MEMS mirror is operating normally, and writes status information into the memory 32 correspondingly. If the difference is out of the acceptable range (NO in step S23), in step S25, the control circuit 30 determines that the input MEMS mirror is out of order, and writes status information into the memory 32 correspondingly.

Thereafter, in step S26, the control circuit 30 determines whether the operational check has been performed on all the unused input MEMS mirrors of the input MEMS mirror arrays 23. If the operational check has not been performed on all the unused input MEMS mirrors of the input MEMS mirror arrays 23 (NO in step S26), the control circuit 30 proceeds to step S22 so as to repeat steps S22 through S26. Thus, the unused input MEMS mirrors are sequentially subjected to this operational check one by one.

The operational check of the input MEMS mirror array 23 and the operational check of the output MEMS mirror array 25 may be performed in parallel at the same time. The above-described operational checks may be performed at any time.

Thus, unused MEMS mirrors are extracted in steps S12 and S22. Accordingly, it is possible to check the operations of the input MEMS mirror array 23 and the output MEMS mirror array 25 while the input MEMS mirror array 23 and the output MEMS mirror array 25 are in operation. A MEMS mirror in use always has signal light input thereto. Therefore, it is possible to determine that the MEMS mirror is out of order if the light level detected in the monitor circuit 14 or 16 is at or below a predetermined threshold.

[Feedback Control]

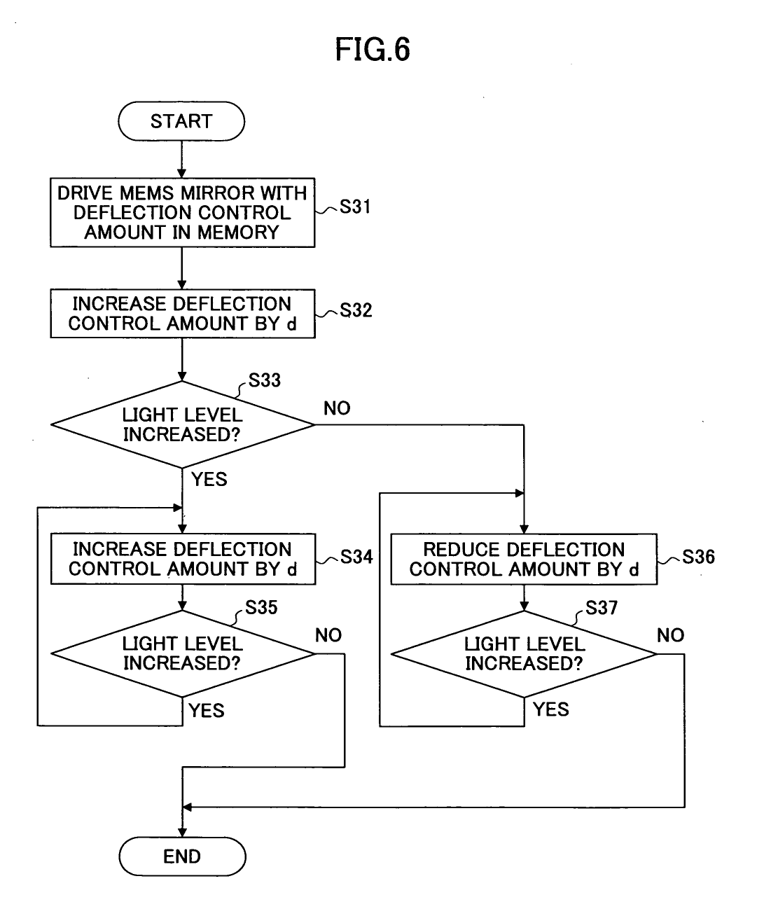

FIG. 6 is a flowchart of feedback control that the control circuit 30 performs on an input or output MEMS mirror. Referring to FIG. 6, in step S31, the control circuit 30 feeds the deflection control amount (initial value) of the input or output MEMS mirror (hereinafter simply referred to as “MEMS mirror”) read out from the memory 32 to the driver circuit 31 so as to drive the MEMS mirror.

Next, in step S32, the control circuit 30 increases the deflection control amount by a minute amount d, and drives the MEMS mirror with the increased deflection control amount. Then, in step S33, the control circuit 30 determines whether the light level of test light monitored in the monitor circuit 16 or 14 has increased.

If the light level has increased (YES in step S33), in step S34, the control circuit 30 increases the deflection control amount by another minute amount d, and drives the MEMS mirror with the increased deflection control amount. Then, in step S35, the control circuit 30 determines whether the light level of the test light monitored in the monitor circuit 16 or 14 has increased. If the light level has increased (YES in step S35), the control circuit 30 proceeds to step S34 so as to repeat steps S34 and S35. If the light level has not increased (NO in step S35), the control circuit 30 ends this operation.

On the other hand, if the light level has not increased in step S33 (NO in step S33), in step S36, the control circuit 30 reduces the deflection control amount by the minute amount d, and drives the MEMS mirror with the reduced deflection control amount. Then, in step S37, the control circuit 30 determines whether the light level of the test light monitored in the monitor circuit 16 or 14 has increased. If the light level has increased (YES in step S37), the control circuit 30 proceeds to step S36 so as to repeat steps S36 and S37. If the light level has not increased (NO in step S37), the control circuit 30 ends this operation.

Thus, employment of the optical switch configuration and the failure detection control method according to this embodiment makes it possible to detect failure of a MEMS mirror without connecting a light source to each port. Therefore, it is possible to increase the reliability of an optical communications system, and at the same time to reduce the cost and size of an optical switch.

According to one embodiment of the present invention, there is provided a micro electro mechanical systems optical switch device including an optical system configured to deflect light signals input from multiple input ports thereof with multiple input deflection parts and multiple output deflection parts on a channel-by-channel basis, and to output the light signals from multiple output ports thereof; a first test light generation part configured to generate first test light and feed the first test light to a specific one of the input ports of the optical system; a first divergence part configured to diverge the first test light fed from the optical system, the first divergence part being provided for each of the output ports of the optical system; a first monitoring part configured to detect the first test light diverged by the first divergence part; a second test light generation part configured to generate second test light and feed the second test light to a specific one of the output ports of the optical system; a second divergence part configured to diverge the second test light fed from the optical system, the second divergence part being provided for each of the input ports of the optical system; a second monitoring part configured to detect the second test light diverged by the second divergence part; and an operational check part configured to cause the first test light to be incident on the output deflection parts one after another by driving a specific one of the input deflection parts corresponding to the specific one of the input ports, and perform an operational check on the output deflection parts from the light level of the first test light detected by the first monitoring part; and to cause the second test light to be incident on the input deflection parts one after another by driving a specific one of the output deflection parts corresponding to the specific one of the output ports, and perform an operational check on the input deflection parts from the light level of the second test light detected by the second monitoring part.

The laser diode 13 may correspond to the first test light generation part, the laser diode 17 may correspond to the second test light generation part, the wavelength filters 15-0 through 15-N may correspond to the first divergence part, the wavelength filters 11-0 through 11-N may correspond to the second divergence part, the monitor circuit 16 may correspond to the first monitoring part, the monitor circuit 14 may correspond to the second monitoring part, the control circuit 30 may correspond to the operational check part, and steps S31 through S37 may correspond to a feedback control part of the operational check part.

According to one aspect of the present invention, it is possible to significantly reduce the number of light sources of test light for abnormality detection, so that it is possible to reduce the cost and size of a MEMS optical switch device.

The present invention is not limited to the specifically disclosed embodiment, and variations and modifications may be made without departing from the scope of the present invention.

The present application is based on Japanese Priority Patent Application No. 2006-230975, filed on Aug. 28, 2006, the entire contents of which are hereby incorporated by reference.

What is claimed is:

1. A micro electro mechanical systems optical switch device, comprising:
an optical system configured to deflect light signals input from a plurality of input ports thereof with a plurality of input deflection parts and a plurality of output deflection parts on a channel-by-channel basis, and to output the light signals from a plurality of output ports thereof;
a first test light generation part configured to generate first test light and feed the first test light to at least one specific input port of the input ports of the optical system;
a first divergence part configured to diverge the first test light fed from the optical system, the first divergence part being provided for each of the output ports of the optical system;
a first monitoring part configured to detect the first test light diverged by the first divergence part;
a second test light generation part configured to generate second test light and feed the second test light to at least one specific output port of the output ports of the optical system;
a second divergence part configured to diverge the second test light fed from the optical system, the second divergence part being provided for each of the input ports of the optical system;
a second monitoring part configured to detect the second test light diverged by the second divergence part; and
an operational check part configured to cause the first test light to be incident on the output deflection parts one after another by driving a specific one of the input deflection parts corresponding to the at least one specific input port, and perform an operational check on the output deflection parts from a light level of the first test light detected by the first monitoring part; and to cause the second test light to be incident on the input deflection parts one after another by driving a specific one of the output deflection parts corresponding to the at least one specific output port, and perform an operational check on the input deflection parts from a light level of the second test light detected by the second monitoring part.

2. The micro electro mechanical systems optical switch device as claimed in claim 1, wherein the operational check part causes the first test light to be incident on one or more unused ones of the output deflection parts one after another in performing the operational check on the output deflection parts, and causes the second test light to be incident on one or more unused ones of the input deflection parts one after another in performing the operational check on the input deflection parts.

3. The micro electro mechanical systems optical switch device as claimed in claim 1, wherein the operational check part comprises a feedback control part configured to perform feedback control of a deflection control amount on the output deflection parts so that the light level of the first test light detected by the first monitoring part is maximized at a time of causing the first test light to be incident on the output deflection parts one after another by driving the specific one of the input deflection parts corresponding to the at least one specific input port, and to perform feedback control of a deflection control amount on the input deflection parts so that the light level of the second test light detected by the second monitoring part is maximized at a time of causing the second test light to be incident on the input deflection parts one after another by driving the specific one of the output deflection parts corresponding to the at least one specific output port.

4. The micro electro mechanical systems optical switch device as claimed in claim 1, wherein the operational check part determines that a corresponding one of the output deflection parts is out of order if a difference between a level of the first test light at a time of the generation thereof in the first test light generation part and the level of the first test light detected by the first monitoring part is out of a first acceptable range, and determines that a corresponding one of the input deflection parts is out of order if a difference between a level of the second test light at a time of the generation thereof in the second test light generation part and the level of the second test light detected by the second monitoring part is out of a second acceptable range.

5. The micro electro mechanical systems optical switch device as claimed in claim 1, wherein the first test light generation part feeds the first test light to two or more specific ones of the input ports of the optical system.

6. The micro electro mechanical systems optical switch device as claimed in claim 1, wherein the second test light generation part feeds the second test light to two or more specific ones of the output ports of the optical system.

7. The micro electro mechanical systems optical switch device as claimed in claim 1, wherein each of the first test light and the second test light is of a specific wavelength.
